(19) United States
(12) Patent Application Publication
(10) Pub. No.: US 2025/0256318 A1
(43) Pub. Date: Aug. 14, 2025

(54) Forming Machine Having a Cutting Device

(71) Applicant: Hatebur Umformmaschinen AG, Reinach (CH)

(72) Inventor: Marco Volonté, Nunningen (CH)

(21) Appl. No.: 19/104,127

(22) PCT Filed: Aug. 14, 2023
(86) PCT No.: PCT/CH2023/050028

§ 371 Date: Feb. 14, 2025

(30) Foreign Application Priority Data
Aug. 16, 2022 (CH) CH000967/2022

(51) Int. Cl. B21D 28/00

(52) U.S. Cl. CPC B21D 28/00

(57) ABSTRACT

A forming machine; has a forming station and a cutting device for cutting off a bar section from a bar material and feeding the cut-off bar section to the forming station. The cutting device comprises a cutting carriage which is movable forwards and backwards and a cutting blade which is attached to the cutting carriage. With the cutting blade, in a forward movement of the cutting carriage the bar section can be cut off from the bar material and fed to the forming station. The cutting device comprises means for adjusting the stroke and the direction of forward movement of the cutting carriage. This makes it possible for the cut-off bar section to be positioned in the forming station in an optimum way.

### CROSS-REFERENCE TO RELATED APPLICATIONS

This application is the United States national phase of International Patent Application No. PCT/CH2023/050028 filed Aug. 14, 2023, and claims priority to Swiss Patent Application No. CH000967/2022 filed Aug. 16, 2022, the disclosures of which are hereby incorporated by reference in their entireties.

### BACKGROUND

### Field

The present invention relates to a forming machine having a forming station and having a cutting device for cutting off a bar section from a bar material as described herein and to a method for cutting off a bar section from a bar material as described herein.

### Description of Related Art

Multi-step forming machines having a plurality of forming stations that are arranged one after the other and have a cutting device for cutting off a bar section from a bar material are known from the prior art. Such forming machines include inter alia those in which the cutting device serves not only for cutting off the bar section from the bar material but also for feeding the cut-off bar section to a first forming station. DE 29 40 375 C2 discloses such a forming machine, in which the cutting device comprises a cutting carriage which is movable forwards and backwards and a cutting blade which is attached to the cutting carriage. With the cutting blade, in a first forward movement of the cutting carriage the bar section can first be cut off from the bar material and then fed to the first forming station. The cutting carriage is driven by a double cam by means of a dual roller lever. Adjustment of the positioning of the cut-off bar section in the first forming station is not possible with this, and is especially not possible during ongoing operation without stoppage of the machine. This is disadvantageous because, due to the cutting, the cut-off bar section usually has irregular geometry and the centre of gravity does not always lie in a rotational axis. In order to obtain optimum volume distribution in the first forming station, the cut-off bar section should therefore be positioned in the first forming station in the most optimum way. This could be achieved, for example, by adjusting the positioning by means of adjustment plates and adjusting screws, but would result in a longer machine stoppage time. This is all the more problematic because the adjustment procedure in some cases has to be repeated several times until the volume distribution in the first forming station is uniform.

### SUMMARY

Against this background, the problem underlying the invention is to provide a forming machine having a forming station and having a cutting device and a method for cutting off a bar section from a bar material of the kind mentioned at the beginning, by means of which the position of a bar section that has been cut off from a bar material and fed to the forming station can be optimally adjusted in the forming station in a simple way and as far as possible without complete stoppage of the machine.

That problem is solved by the forming machine according to the invention and by the method according to the invention for cutting off a bar section, as defined herein. Especially advantageous developments and embodiments will be apparent from the dependent patent claims.

The core of the invention in respect of the forming machine is as follows: a forming machine has a forming station and a cutting device for cutting off a bar section from a bar material and feeding the cut-off bar section to the forming station. The cutting device comprises a cutting carriage which is movable forwards and backwards and a cutting blade which is attached to the cutting carriage. With the cutting blade, in a forward movement of the cutting carriage the bar section can be cut off from the bar material and fed to the forming station. The cutting device comprises means for adjusting the stroke and the direction of forward movement of the cutting carriage.

In the present context, “bar material” is to be understood as being any form of material having a marked longitudinal extent and any desired cross-section which is usually constant over the longitudinal extent. Metal rods, bars and wires of any dimensions especially fall under this definition. Circular cross-sections are the rule, but the invention is not limited thereto. The bar material can extend along a straight line or can also be rolled up.

“Movable forwards and backwards” includes movements in a horizontal, vertical or oblique spatial direction.

Because the cutting device comprises means for adjusting the stroke and the direction of forward movement of the cutting carriage, it is possible for the position of a bar section that has been cut off from a bar material and fed to the forming station to be optimally adjusted in the forming station in a simple way. In comparison with the prior art, this results in a significant time-saving and in a reduction in machine stoppage times.

Advantageously, the means for adjusting the stroke and the direction of forward movement of the cutting carriage are configured so that they enable the stroke and the direction of forward movement of the cutting carriage to be adjusted during ongoing operation of the forming machine, the forming machine preferably comprising a control unit for controlling the means for adjusting the stroke and the direction of forward movement of the cutting carriage.

The possibility of adjusting the stroke and the direction of forward movement of the cutting carriage during ongoing operation of the forming machine means that it is possible to avoid complete stoppage of the machine during adjustment of the positioning of the cut-off bar section in the forming station. In comparison with the prior art, this results in a significant time-saving and in a reduction in machine stoppage times.

A control unit for controlling the means for adjusting the stroke and the direction of forward movement of the cutting carriage allows simple operation of those means as well as, if desired, automation.

Advantageously, the cutting device comprises a variable-stroke cutting carriage drive with which the cutting carriage is movable forwards and backwards. With such a cutting carriage drive, the adjustment of the stroke of the forward movement of the cutting carriage can be realised in a simple way.

The cutting carriage drive is preferably independent of the drive of the forming tools in the said forming station and any further forming stations of the forming machine.

Preferably, the cutting carriage drive comprises a hydraulic cylinder and a piston displaceable therein, the piston being connected to the cutting carriage via a piston rod. With such a cutting carriage drive it is simple to realise a variable stroke which is controllable by a control unit.

Advantageously, for adjustment of the direction of forward movement of the cutting carriage, the cutting carriage is pivotable about a pivot axis. Pivoting of the cutting carriage allows simple adjustment of the direction of movement.

Preferably, the cutting carriage is movable forwards and backwards transversely with respect to a longitudinal direction of the bar section and the pivot axis runs parallel to the longitudinal direction of the bar section.

The fact that the cutting carriage is movable forwards and backwards transversely with respect to a longitudinal direction of the bar section means that, in a forward movement of the cutting carriage, the bar section can be cut off from the bar material in a straight line transversely with respect to the longitudinal direction of the bar section and the cut-off bar section can then be fed to the forming station in the same step.

Because the pivot axis of the cutting carriage runs parallel to the longitudinal direction of the bar section, the positioning of the cut-off bar section in the forming station can be adjusted in a plane perpendicular to the pivot axis of the cutting carriage and to the longitudinal direction of the bar section. Together with the variable stroke of the cutting carriage, this allows specific positioning of the cut-off bar section in the forming station in that plane.

Advantageously, the cutting carriage is guided in a cutting carriage bearing which is at least to some extent pivotable about the pivot axis. The pivoting of the cutting carriage and therewith the adjustment of the direction of forward movement of the cutting carriage can thus be effected via the cutting carriage bearing.

Preferably, the means for adjusting the stroke and the direction of forward movement of the cutting carriage comprise a pivot angle adjusting device which acts decentrally on the cutting carriage bearing and, on adjustment, adjusts a pivot angle of the cutting carriage bearing, the pivot angle adjusting device preferably comprising an eccentric. Such a pivot angle adjusting device enables the pivot angle of the cutting carriage bearing and therewith the direction of forward movement of the cutting carriage to be adjusted in a simple way.

In a preferred embodiment, the cutting carriage bearing is connected to at least one static attachment part by means of at least one resiliently deformable connecting part. In this way, maintenance work can be reduced, because a high-maintenance hinge is not required.

In respect of the method, the core of the invention is as follows: In a method for cutting off a bar section from a bar material and feeding the cut-off bar section to a forming station of a forming machine, a cutting device comprises a cutting carriage which is movable forwards and backwards and a cutting blade which is attached to the cutting carriage. By means of the cutting device, in a forward movement of the cutting carriage the cutting blade cuts off the bar section from the bar material and feeds that bar section to the forming station. For positioning the cut-off bar section in the forming station, the stroke and the direction of forward movement of the cutting carriage are adjusted.

The adjustment of the stroke and the direction of forward movement of the cutting carriage enables the position of a bar section that has been cut off from a bar material and fed to the forming station to be optimally adjusted in the forming station in a simple way. In comparison with the prior art, this results in a significant time-saving and in a reduction in machine stoppage times.

### BRIEF DESCRIPTION OF THE DRAWINGS

The terms Fig., Figs., Figure, and Figures are used interchangeably in the specification to refer to the corresponding figures in the drawings.

The forming machine according to the invention and the method according to the invention for cutting off a bar section are described in greater detail below with reference to an exemplary embodiment which is shown in the drawings, wherein:

FIG. 1—is a partly sectional and partly diagrammatic perspective view of part of a forming machine according to the invention having a cutting device during the cutting-off of a bar section from a bar material;

FIG. 2—is a partly sectional side view of the part of the forming machine and bar section of FIG. 1 with partly omitted machine parts not shown, but additionally showing enlarged detail views;

FIG. 3—is a perspective view of the cutting device of the forming machine of FIG. 1 with a cut-off bar section;

FIG. 4—shows the cutting device with the cut-off bar section of FIG. 3 in a side view seen from the direction of a first forming station of the forming machine;

FIG. 5—is a perspective view of a cutting carriage bearing of the cutting device of FIG. 3;

FIG. 6—is a view of the cutting carriage bearing of FIG. 5 from a different perspective;

FIG. 7—is a partly sectional perspective view of the part of the forming machine and bar section of FIG. 1 with parts shown purely diagrammatically not shown, but with the cut-off bar section positioned centrally in the first forming station;

FIG. 8—is a partly sectional side view of the part of the forming machine and bar section of FIG. 7 with partly omitted machine parts not shown, but additionally showing enlarged detail views;

FIG. 9—is a partly sectional perspective view of the part of the forming machine and bar section of FIG. 7, but with the cut-off bar section in a position displaced towards top right in the first forming station;

FIG. 10—is a partly sectional side view of the part of the forming machine and bar section of FIG. 9 with partly omitted machine parts not shown, but additionally showing enlarged detail views;

FIG. 11—is a partly sectional perspective view of the part of the forming machine and bar section of FIG. 7, but with the cut-off bar section in a position displaced towards bottom left in the first forming station; and

FIG. 12—is a partly sectional side view of the part of the forming machine and bar section of FIG. 11 with partly omitted machine parts not shown, but additionally showing enlarged detail views.

### DESCRIPTION

The following observations apply in respect of the description which follows: where, for the purpose of clarity of the drawings, reference signs are included in a Figure but are not mentioned in the directly associated part of the description, reference should be made to the explanation of those reference symbols in the preceding or subsequent parts of the description. Conversely, to avoid overcomplication of the drawings, reference signs that are less relevant for immediate understanding are not included in all Figures. In that case, reference should be made to the other Figures.

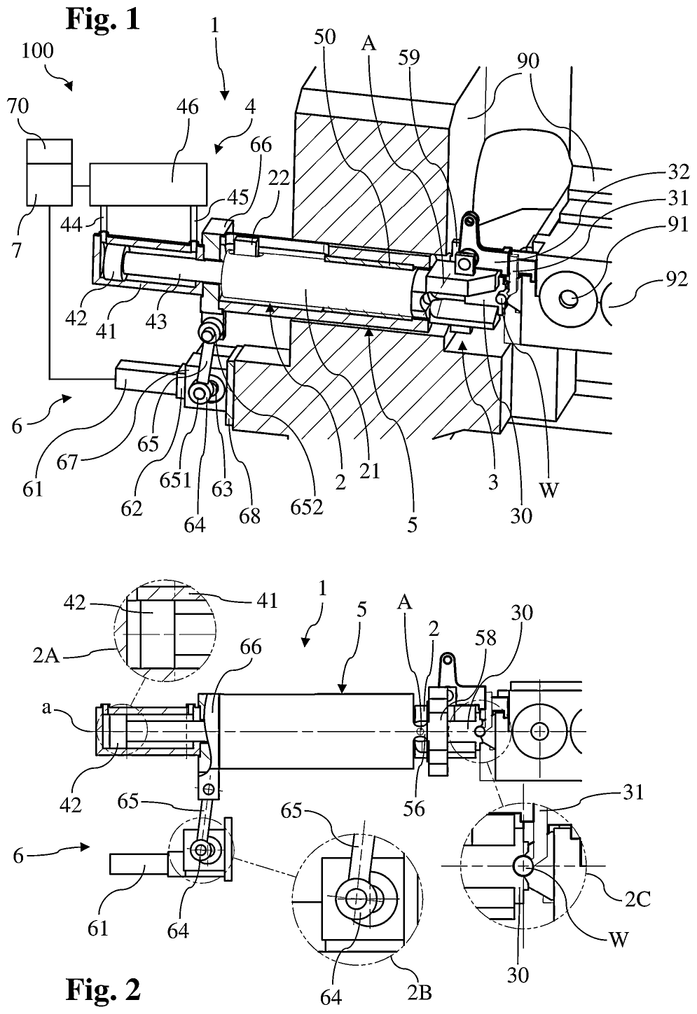

FIG. 1 is a partly sectional and partly diagrammatic perspective view of part of an exemplary embodiment of a forming machine 100 according to the invention, which in this case is a multi-step forming machine. The forming machine 100 comprises a machine body 90 in which a plurality of successive forming stations 91, 92, etc. for stepwise forming of a workpiece are arranged in known manner. Of the successive forming stations, only the die-side part of the first forming station 91 and part of the die-side part of the forming station 92 are visible in FIG. 1.

The forming machine 100 further comprises a cutting device 1, which is likewise attached to the machine body 90 and with which the workpiece that is to undergo forming in the first forming station 91, in the form of a bar section W, can be cut off from a bar material and fed to the first forming station 91. The bar material here consists of a metal bar which extends obliquely towards the rear from the bar section W visible in FIG. 1 but, apart from the bar section W, is entirely concealed by machine parts of the forming machine.

The cutting device 1 comprises a cutting carriage bearing 5, which extends through a cylindrical opening of the machine body 90 and in which a cutting carriage 2 is mounted so as to be movable forwards and backwards in a longitudinal direction. In a sub-region of the cutting carriage bearing 5, a slide bush 50 is arranged between the cutting carriage 2 and the cutting carriage bearing 5, which slide bush supports the cutting carriage 2 so as to be readily slidable.

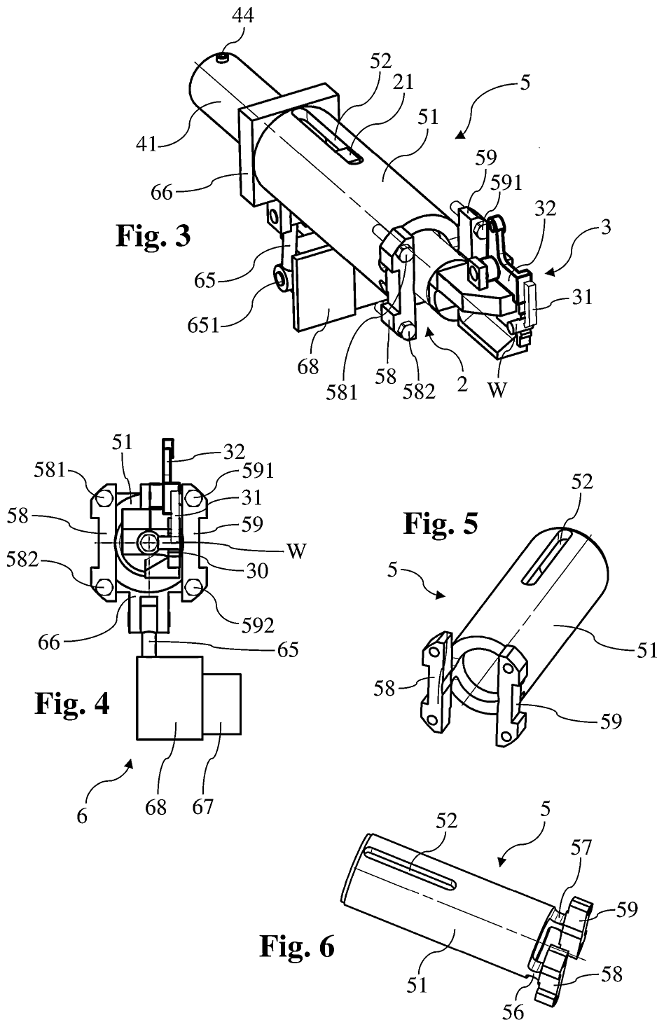

As can best be seen from FIGS. 5 and 6, the cutting carriage bearing 5 has a hollow-cylindrical main body 51 which is provided on the upper side with a slot 52 running in a longitudinal direction. The hollow-cylindrical main body 51 is connected via two connecting parts 56 and 57 to two attachment parts 58 and 59, respectively. The hollow-cylindrical main body 51, the two connecting parts 56, 57 and the two attachment parts 58, 59 are formed in one piece. The cutting carriage bearing 5 is screwed to the machine body 90 via the two attachment parts 58, 59 by means of screws 581, 582, 591, 592, see especially FIGS. 1, 3, 4 and 7, and so on one side is fixed and static. The hollow-cylindrical main body 51 is pivotable through a small angle with respect to that static part of the cutting carriage bearing 5. As shown in FIGS. 1 and 2, the pivot axis A runs through the relatively thin connecting parts 56, 57, which are resiliently deformable. The resilient deformability means that a high-maintenance hinge is not required.

For pivoting the hollow-cylindrical main body 51 about the pivot axis A, the cutting device 1 has a pivot angle adjusting device 6. As can be seen especially from FIGS. 1 to 4, the pivot angle adjusting device 6 comprises a servo motor 61 with which a drive shaft 63 having an eccentric disc 64 is rotatable via a gear mechanism 62, especially a worm gear. The drive shaft 63 is arranged in a housing 67 which is attached to the machine body 90 via an attachment plate 68. An eccentric arm 65 is connected by one eccentric arm end 651 to the eccentric disc 64 and by its other eccentric arm end 652 is articulated on an adjusting collar 66 which is connected to an end region of the hollow-cylindrical main body 51 of the cutting carriage bearing 5 and is arranged around the latter. The drive shaft 63, the eccentric disc 64 and the eccentric arm 65 together form an eccentric. Rotation of the shaft 63 with the eccentric disc 64 displaces the eccentric arm 65 connected to the eccentric disc 64 at the eccentric arm end 651 and in that way in turn effects translational displacement of the adjusting collar 66 connected to the cutting carriage bearing 5, thereby raising or lowering the end region of the hollow-cylindrical main body 51 of the cutting carriage bearing 5 that is connected thereto. This results in pivoting of the hollow-cylindrical main body 51 about the pivot axis A or adjustment of the pivot angle a of the cutting carriage bearing 5 or the hollow-cylindrical main body 51 of the cutting carriage bearing 5, which pivot angle is indicated in FIGS. 10 and 12.

Referring to FIG. 10, the pivot angle a can be defined as the angle between the longitudinal direction g of the hollow-cylindrical main body 51 of the cutting carriage bearing 5 in the state in which it is pivoted about the pivot axis A and the longitudinal direction a of the hollow-cylindrical main body 51 of the cutting carriage bearing 5 in the state in which it is not pivoted with respect to the static part of the cutting carriage bearing 5. The longitudinal direction g indicated in FIG. 10 is the centre axis of the hollow-cylindrical main body 51 of the cutting carriage bearing 5. The unpivoted state of the hollow-cylindrical main body 51 of the cutting carriage bearing 5 is shown in FIG. 2. The longitudinal direction a indicated therein there corresponds to the centre axis of the hollow-cylindrical main body 51 of the cutting carriage bearing 5.

The pivot angle a is adjustable in a range of from −20° to 20°. Preferably the forming machine is dimensioned so that an adjustment range of from −10° to 10°, more preferably from −5° to 5°, is sufficient.

As can best be seen from FIGS. 1, 3 and 4, the cutting carriage 2 mounted in the cutting carriage bearing 5 has a cylindrical main body 21, away from which a lug 22 extends upwards. The lug 22 engages in the slot 52 of the hollow-cylindrical main body 51 of the cutting carriage bearing 5 and together therewith thus forms an anti-rotation device.

A cutting head 3 is attached to the cutting carriage 2 on its side that faces towards the first forming station 91, which cutting head has a cutting blade 30 which is open on the side facing towards the first forming station 91 and bears against the bar section W. By means of a section holder 31, which is mounted on a rotatable lever 32, the bar section W is pressed against the cutting blade 30 from the other side, this serving to hold the bar section W, once it has been cut off from the bar material, against the cutting blade 30 and to transport the bar section so held to the first forming station 91. The cutting-off of the bar section W from the bar material and the transport or feeding of the cut-off bar section to the first forming station 91 is effected by forward movement of the cutting carriage 2 with the cutting head 3 and the cutting blade 30 in the direction towards the first forming station 91. The rotatable lever 32 with the mounted section holder 31 is operated in such a way that, once a bar section W to be cut off has been placed in front of the cutting blade 30 by advancement of bar material, it presses the bar section W against the cutting blade 30 and holds the latter pressed against the bar section until the cut-off bar section has been fed to the first forming station 91 and taken over by the holding device therein. Everything that has been said in this paragraph and the details of how it is implemented are known to the person skilled in the art and are described comprehensively in DE 29 40 375 C2, the disclosure of which is therefore herewith explicitly incorporated by reference. The person skilled in the art needs no further explanation in this regard.

For the forward and backward movement of the cutting carriage 2, the cutting device 1 has a variable-stroke cutting carriage drive 4. The cutting carriage drive 4 comprises a hydraulic cylinder 41 and a piston 42 displaceable therein, the piston 42 being connected to the cutting carriage 2 via a piston rod 43. As shown diagrammatically in FIG. 1, the hydraulic cylinder 41 communicates with a fluid reservoir 46 via a hydraulic line 44, which has its mouth behind the piston 42, and a hydraulic line 45 which has its mouth in front of the piston 42. By feeding hydraulic fluid from the fluid reservoir 46 via the hydraulic line 44 behind the piston 42 and discharging hydraulic fluid via the hydraulic line 45, the cutting carriage 2 is moved forwards in the direction towards the first forming station 91, while by feeding hydraulic fluid from the fluid reservoir 46 via the hydraulic line 45 in front of the piston 42 and discharging hydraulic fluid via the hydraulic line 44, the cutting carriage 2 is moved towards the rear away from the first forming station 91. The stroke of the cutting carriage 2 can be adjusted by controlling the amount of hydraulic fluid supplied.

To control both the cutting carriage drive 4 and the pivot angle adjusting device 6, the forming machine 100 has a control unit 7 which is shown diagrammatically in FIG. 1. The control unit 7 allows simple operation both of the cutting carriage drive 4 and of the pivot angle adjusting device 6, for example by means of an input unit 70, with which a desired stroke of the cutting carriage 2 and a desired direction of forward movement of the cutting carriage 2 or a desired pivot angle a of the cutting carriage bearing 5 or directly a desired positioning of the bar section W in the first forming station 91 can be input. If desired, extensive automation can be carried out by means of the control unit 7.

As already mentioned, the cutting carriage 2 is mounted in the cutting carriage bearing 5 so as to be movable forwards and backwards in a longitudinal direction. While so doing it is guided by the slide bush 50 which is arranged in a sub-region of the cutting carriage bearing 5 between the cutting carriage 2 and the hollow-cylindrical main body 51 of the cutting carriage bearing 5, see especially FIG. 1. As a result, the longitudinal direction of the cutting carriage 2 in which the latter is moved forwards and backwards corresponds to the longitudinal direction g of the hollow-cylindrical main body 51 of the cutting carriage bearing 5. The cutting carriage 2 has the same pivot axis A and the same pivot angle a as the hollow-cylindrical main body 51 of the cutting carriage bearing 5.

The pivot axis A preferably runs parallel to the longitudinal direction of the bar section W to be cut off and the cutting carriage 2 is preferably movable forwards and backwards transversely with respect to the longitudinal direction of the bar section W.

FIG. 2 shows the unpivoted state of the hollow-cylindrical main body 51 of the cutting carriage bearing 5. The pivot angle a is 0. The longitudinal direction a indicated in the drawing corresponds to the centre axis of the hollow-cylindrical main body 51 of the cutting carriage bearing 5 and to the longitudinal direction and centre axis of the cutting carriage 2. The eccentric disc 64, the eccentric arm 65 and the adjusting collar 66 are located in a central position, as can also be seen from detail 2B. According to detail 2A, the piston 42 is located almost at the left-hand edge of the hydraulic cylinder 41, that is to say almost in the position in which it has moved furthest to the rear. According to detail 2C, the cutting blade 30 is in contact with the as yet uncut bar section W, which is held on the other side by the section holder 31.

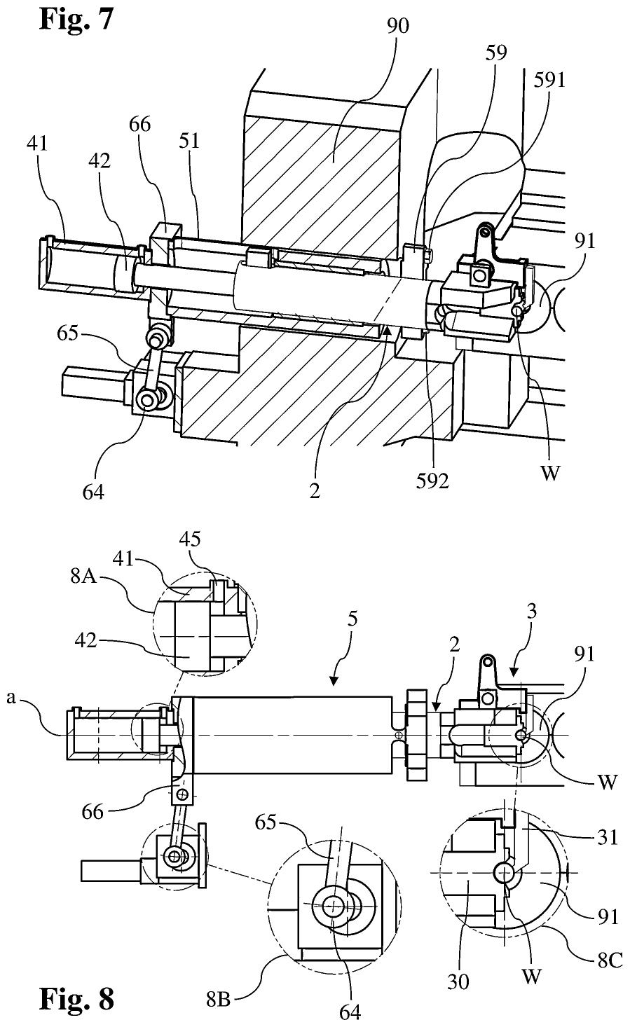

By forward movement of the cutting carriage 2 in the longitudinal direction a as a result of movement of the piston 42 in the hydraulic cylinder 41 in that direction, the bar section W is cut off from the bar material and transported or fed to the first forming station 91. The state shown in FIGS. 7 and 8 is reached, where according to detail 8C the bar section W is positioned centrally in the first forming station 91. According to detail 8A, the piston 42 is located close to the right-hand edge of the hydraulic cylinder 41, but would still be movable further to the right. The details 8A and 8C show a medium stroke of the cutting carriage 2. The eccentric disc 64, the eccentric arm 65 and the adjusting collar 66 have not been displaced and remain in the central position, see also detail 8B.

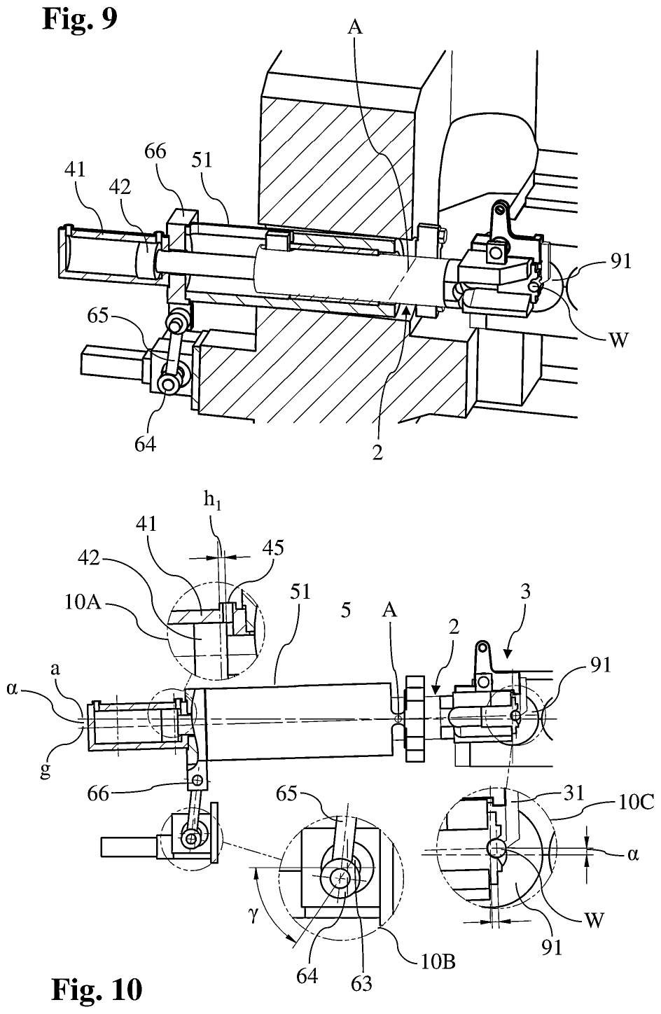

FIGS. 9 and 10 show a different situation in which the bar section W according to detail 10C is in a position displaced towards top right in the first forming station 91. This has been achieved, on the one hand, by an increased stroke, which can be seen in detail 10A by the piston 42 having moved further to the right in comparison with detail 8A. The piston 42 here even covers part of the mouth of the hydraulic line 45 into the hydraulic cylinder 41. The stroke, which has been increased by the distance h₁, is here about 1.5 mm.

The displacement of the bar section W upwards in the first forming station 91 has been achieved according to detail 10B by anticlockwise rotation of the drive shaft 63 through an angle γ, which has correspondingly rotated the eccentric disc 64 therewith and pulled the eccentric arm 65 and the adjusting collar 66 downwards, which has in turn pivoted the hollow-cylindrical main body 51 of the cutting carriage bearing 5 downwards through pivot angle a in relation to the pivot axis A. As a consequence, to the left of the pivot axis A the cutting carriage 2 has likewise been pivoted downwards through pivot angle a and to the right of the pivot axis A upwards through pivot angle a.

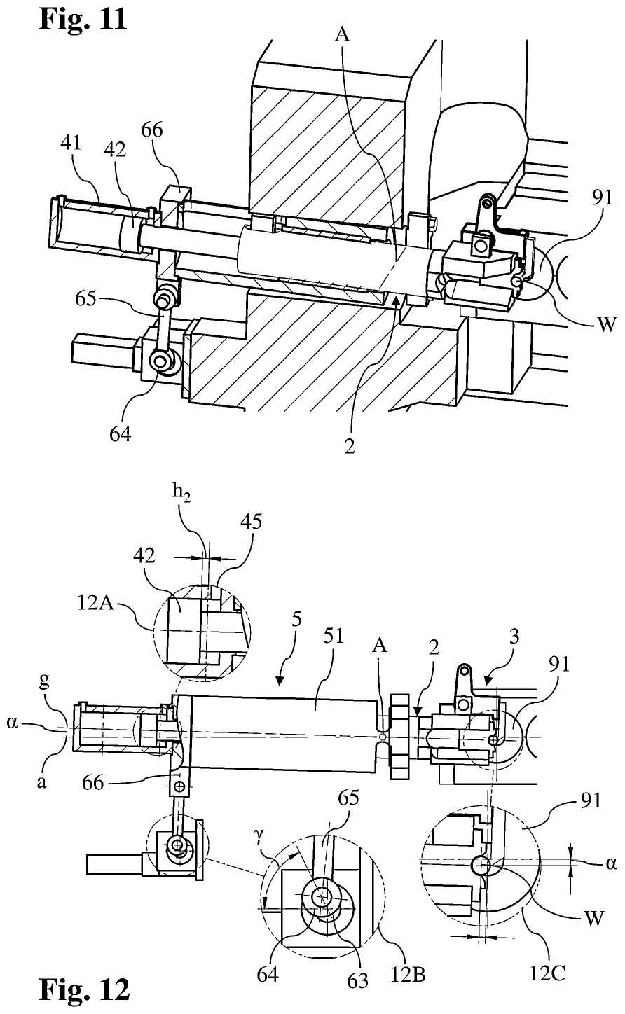

FIGS. 11 and 12 in turn show a different situation in which the bar section W according to detail 12C is in a position displaced towards bottom left in the first forming station 91. This has been achieved, on the one hand, by a reduced stroke, which can be seen in detail 12A by the piston 42 having moved further to the left in comparison with detail 8A. The piston 42 is further away from the mouth of the hydraulic line 45 into the hydraulic cylinder 41. The stroke, which has been reduced by the distance h₂, is here about 1.5 mm.

The displacement of the bar section W downwards in the first forming station 91 has been achieved according to detail 12B by clockwise rotation of the drive shaft 63 through an angle γ, which has correspondingly rotated the eccentric disc 64 therewith and pushed the eccentric arm 65 and the adjusting collar 66 upwards, which has in turn pivoted the hollow-cylindrical main body 51 of the cutting carriage bearing 5 upwards through pivot angle a in relation to the pivot axis A. As a consequence, to the left of the pivot axis A the cutting carriage 2 has likewise been pivoted upwards through pivot angle a and to the right of the pivot axis A downwards through pivot angle a.

1. A forming machine having a forming station and having a cutting device for cutting off a bar section from a bar material and feeding the cut-off bar section to the forming station, wherein the cutting device comprises a cutting carriage which is movable forwards and backwards and a cutting blade which is attached to the cutting carriage, with which cutting blade, in a forward movement of the cutting carriage, the bar section can be cut off from the bar material and fed to the forming station, characterised in that the cutting device comprises means for adjusting the stroke and the direction of forward movement of the cutting carriage.

2. The forming machine according to claim 1, wherein the means for adjusting the stroke and the direction of forward movement of the cutting carriage are configured so that they enable the stroke and the direction of forward movement of the cutting carriage to be adjusted during ongoing operation of the forming machine, the forming machine; preferably comprising a control unit for controlling the means for adjusting the stroke and the direction of forward movement of the cutting carriage.

3. The forming machine according to claim 1, wherein the cutting device comprises a variable-stroke cutting carriage drive with which the cutting carriage is movable forwards and backwards.

4. The forming machine according to claim 3, wherein the cutting carriage drive comprises a hydraulic cylinder and a piston displaceable therein, the piston being connected to the cutting carriage via a piston rod.

5. The forming machine according to claim 1, wherein for adjustment of the direction of forward movement of the cutting carriage, the cutting carriage is pivotable about a pivot axis.

6. The forming machine according to claim 5, wherein the cutting carriage is movable forwards and backwards transversely with respect to a longitudinal direction of the bar section and the pivot axis runs parallel to the longitudinal direction of the bar section.

7. The forming machine according to claim 5, wherein the cutting carriage is guided in a cutting carriage bearing which is at least to some extent pivotable about the pivot axis.

8. The forming machine according to claim 7, wherein the means for adjusting the stroke and the direction of forward movement of the cutting carriage comprise a pivot angle adjusting device which acts decentrally on the cutting carriage bearing and, on adjustment, adjusts a pivot angle of the cutting carriage bearing, the pivot angle adjusting device preferably comprising an eccentric.

9. The forming machine according to claim 7, wherein the cutting carriage bearing is connected to at least one static attachment part by means of at least one resiliently deformable connecting part.

10. A method for cutting off a bar section from a bar material and feeding the cut-off bar section to a forming station of a forming machine, wherein by means of a cutting device, which comprises a cutting carriage which is movable forwards and backwards and a cutting blade which is attached to the cutting carriage, in a forward movement of the cutting carriage the cutting blade; cuts off the bar section from the bar material and feeds it to the forming station, wherein for positioning the cut-off bar section in the forming station, the stroke and the direction of forward movement of the cutting carriage are adjusted.
